(19) United States
(12) Patent Application Publication
(10) Pub. No.: US 2006/0171979 A1
(43) Pub. Date: Aug. 3, 2006

(54) Fungicide mixture formulations

(76) Inventors: Jose-Luis Calvo, Bracknell (GB); David Bartlett, Bracknell (GB); Christopher Saunders, Kent (GB); Allison Tally, Greensboro, NC (US); Xinyun Wen, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 11/339,280

(22) Filed: Jan. 25, 2006

Related U.S. Application Data
(60) Provisional application No. 60/648,761, filed on Feb. 1, 2005.

(51) Int. Cl. A01N 43/54; A01N 25/00

(52) U.S. Cl. 424/405; 514/269

(57) ABSTRACT

There is provided a fungicidal concentrate comprising azoxystrobin and propiconazole, wherein the concentrate is a suspoemulsion having an aqueous phase, an oil phase and particles dispersed in the aqueous and/or oil phase. Also provided is a method of using the compositions for combating and/or preventing fungal diseases in crops of useful plants.

The present invention relates to suspoemulsions comprising azoxystrobin and propiconazole. The present invention also relates to fungicidal compositions for controlling diseases in crops of useful plants prepared from these suspoemulsions and to the use of such compositions for combating and/or preventing fungal diseases in crops of useful plants.

### BACKGROUND OF THE INVENTION

Azoxystrobin and propiconazole are both well-known fungicides; they are described in The Pesticide Manual [Twelfth Edition, Editor: C. D. S. Tomlin] as entries 49 and 651, respectively. Research Disclosure 33893, published in June 1992, discusses the use of azoxystrobin as a fungicide and further discusses the possibility of its use with one or more other fungicides. Propiconazole is included in a list of possible fungicide partners for azoxystrobin.

Mixtures of fungicides are well known in the art. Mixtures are desirable for increasing the spectrum of fungal disease control as well as a means for resistance management.

Suspoemulsions are a well-known formulation type for agricultural chemicals. Suspoemulsions are formulations that combine a suspension and an emulsion or microemulsion.

### SUMMARY OF THE INVENTION

In one embodiment, the present invention relates to a suspoemulsion comprising azoxystrobin and propiconazole.

In another embodiment, the invention relates to a suspoemulsion formulation comprising:
(A) a continuous aqueous phase;
(B) (i) a dispersed emulsion phase comprising at least one liquid, water-insoluble active ingredient comprising propiconazole;
   (ii) an emulsifier in an amount sufficient to emulsify the liquid, water-insoluble active ingredient(s); and
(c) (i) azoxystrobin, as a dispersed solid phase;
   (ii) a dispersing agent in an amount sufficient to disperse the azoxystrobin as well as any other solid technical materials present in the formulation;
      wherein the solid phase is dispersed in said aqueous and/or emulsion phase.

It is also an object of the invention to provide fungicidal compositions obtained by diluting the suspoemulsions of the present invention in a suitable amount of water so as to obtain the desired concentration of azoxystrobin and propiconazole for application to crops of useful plants, their seeds or seedlings or the crop area thereof.

It is another object of the invention to provide a method for the control of fungal diseases in crops of useful plants, which method comprises treating the useful plants, their seeds or seedlings or the crop area thereof with the fungicidal compositions of the present invention.

These and other objects and features of the invention will be more apparent from the detailed description set forth hereinbelow, and from the appended claims.

### DETAILED DESCRIPTION OF THE PREFERRED EMBODIMENTS

The suspoemulsions of the present invention comprise azoxystrobin and propiconazole. Suitably, this invention comprises a suspoemulsion that comprises azoxystrobin formulated as a suspension and propiconazole formulated as an emulsion; both dispersed in the same continuous aqueous phase.

Preferably, the suspoemulsion comprises:
(A) a continuous aqueous phase;
(B) (i) a dispersed emulsion phase comprising at least one liquid, water-insoluble active ingredient comprising propiconazole;
   (ii) an emulsifier in an amount sufficient to emulsify the liquid, water-insoluble active ingredient(s); and
(c) (i) azoxystrobin, as a dispersed solid phase;
   (iii) a dispersing agent in an amount sufficient to disperse the azoxystrobin as well as any other solid technical materials present in the formulation;
      wherein the solid phase is dispersed in said aqueous and/or emulsion phase.

Solvents may be used to dissolve the propiconazole and form a low viscosity liquid. This liquid mixture can be emulsified in water using a suitable emulsifier and thereby be used to formulate the suspoemulsions of the present invention. Suitable solvents can be determined by one skilled in the art. Particularly suitable solvents include methyl esters of fatty acids derived from fats and oils such as methyl oleate, n-octanol, alkyl phosphates such as tri-n-butyl phospate and isoparaffinic solvents. Preferably, methyl oleate is used as the solvent to dissolve propiconazole prior to forming the suspoemulsions of the present invention.

The azoxystrobin and propiconazole may be present in any desirable ratio. It is preferred that the weight ratio of azoxystrobin to propiconazole is in the range from 5:1 to 1:5; more preferably from 2.5:1 to 1:2.5; even more preferably from 2:1 to 1:2.

The suspoemulsion of the present invention may optionally further comprise one or more additional active ingredients. The one or more additional active ingredients may be a pesticide, for example a herbicide, plant growth regulator, fungicide, insecticide, acaracide or nematicide. The concentration of additional active ingredient in the formulation is suitably in the range of from 1 g/l to 500 g/l, and preferably from 2 g/l to 300 g/l.

The surfactant system which enables the water-insoluble solids to be dispersed in the aqueous phase and the liquid technical materials (active ingredients) to be emulsified in the continuous water phase is typically a mixture of two or more surfactants, at least one of which is a nonionic surfactant and optionally at least one of which is an anionic surfactant.

In a suspoemulsion formulation, surfactants may function as emulsifiers to emulsify oily liquid technical materials or dispersants to disperse solid water-insoluble technical materials. These surfactants should be compatible in one formulation. A surface-active agent may act as both an emulsifier and a dispersant.

Suitable surface-active compounds are, depending on the nature of the active ingredient, non-ionic, cationic and/or anionic surfactants and mixtures of surfactants having good emulsifying, dispersing and wetting properties. Examples of suitable anionic, non-ionic and cationic surfactants are listed, for example, in U.S. Pat. No. 6,063,732 column 5, line 1 to column 6, line 2, the contents of which are incorporated herein by reference.

Furthermore, the surfactants customarily employed in formulation technology, which are described, inter alia, in “Mc Cutcheon's Detergents and Emulsifiers Annual” MC Publishing Corp., Ridgewood N.J., 1981, Stache, H., “Tensid-Taschenbuch”, Carl Hanser Verlag, MunichNienna, 1981 and M. and J. Ash, “Encyclopedia of Surfactants”, Vol I-III, Chemical Publishing Co., New York, 1980-81, are also suitable for preparation of the fungicidal compositions according to the invention.

Surfactants particularly suitable for use in forming the suspoemulsions of the present invention include the sodium salt of naphthalenesulfonic acid-formaldehyde condensates, propylene oxide/ethylene oxide block copolymers such as the PLURONIC® PE series of surfactants available from BASF, hydrophilic methyl methacrylate graft polymers such as ATLOX 4913 from Uniqema, acting as a dispersant; non-ionic surfactants and surfactant blends such as ATLOX 4894 from Uniqema acting as an emulsifier.

The amount of surfactant(s) depends on the particular active ingredients selected for the composition and the absolute and relative amounts of these desired. Suitable amounts of stabilizing system components selected from the classes or specific examples provided herein can be determined by routine experimentation, the test being that substantially no phase separation, sedimentation or flocculation is exhibited by the composition following storage at 20-25° C. for a period of 24 hours, or, for preferred embodiments, following a longer period of storage over a broader range of temperatures as indicated above. Typically the total concentration of all surfactants in the composition as a whole is about 1% to about 30% by weight, excluding the weight of counterions, if present.

These compositions may also comprise other auxiliaries such as biocides, wetting agents, chemical stabilizers, viscosity controlling agents, thickeners, binders, tackifiers, fertilizers and anti-foam agents.

Representative anti-foam agents are silica, polydialkylsiloxanes, in particular polydimethylsiloxanes, fluoroaliphatic esters or perfluoroalkylphosphonic/perfluoroalkylphosphonic acids or the salts thereof and mixtures thereof. Preferred are polydimethylsiloxanes.

The invention relates also to fungicide compositions obtained by i) diluting the suspoemulsion of the present invention in a suitable carrier, such as water, such that the final concentration of the fungicides is between about 0.01% and about 30% of active ingredient (a.i.).

The invention relates also to a method for combating or preventing fungal disease in crops of useful plants, said method comprising forming a fungicide composition by i) diluting the suspoemulsion of the present invention in a suitable carrier, such as water, such that the final concentration of each of the azoxystrobin and propiconazole is between about 0.01% and about 30% of active ingredient (a.i.) and ii) treating the desired area, such as crop, their seeds or seedlings or the crop area, with said composition.

The term plants refers to all physical parts of a plant, including seeds, seedlings, saplings, roots, tubers, stems, stalks, foliage and fruits.

The fungicide compositions according to the invention are suitable for methods of application conventionally used in agriculture, which are readily determinable by one skilled in the art. The compositions according to the invention are preferably used for the control of foliar diseases in crops of useful plants.

The fungicide compositions according to the invention are suitable especially for combating and/or preventing fungal diseases in crops of useful plants, including cereals, grass grown for seed, maize, pecans, rice and soya. “Crops” are to be understood also to include those crops that have been made tolerant to pests and pesticides, as a result of conventional methods of breeding or genetic engineering. The components used in the composition of the invention can be applied in a variety of ways known to those skilled in the art, at various concentrations. The rate at which the compositions are applied will depend upon the particular type of weed to be controlled, the degree of control required, and the timing and method of application.

The fungicidal compositions of the present invention provide control for a broad spectrum of fungal diseases including particularly foliar diseases such as Septoria, powdery mildew and leaf rust

Crop areas are areas of land on which the cultivated plants are already growing or in which the seeds of those cultivated plants have been sown, and also areas of land on which it is intended to grow those cultivated plants.

Other active ingredients such as herbicides, plant growth regulators, co-fungicides, insecticides, acaricides and nematicides may be present in the suspoemulsions of the present invention or may be added as a tank-mix partner with the suspoemulsion formulation.

Fungicide compositions prepared from the suspoemulsions of the present invention may exhibit numerous benefits including improved crop safety compared to compositions obtained by tank mixing azoxystrobin and propiconazole, enhanced systemicity, enhanced biological performance such as better and longer lasting disease control and/or increased crop yield compared to either of the fungicides alone or certain other commercially-available fungicides and fungicide mixtures. Further, the compositions of the present invention are useful as part of an anti-resistance campaign due to the different modes of action of the fungicides.

The following examples illustrate further some of the aspects of the invention but are not intended to limit its scope. Where not otherwise specified throughout this specification and claims, percentages are by weight.

### EXAMPLES

Table 1 sets forth the formulation for a suspoemulsion within the scope of the present invention (Suspoemulsion A). The amounts of components are set forth as percentages on a weight/weight basis.

TABLE 1
Suspoemulsion A

| | |
|---|---|
| azoxystrobin | 7 |
| propiconazole | 11.7 |
| Methyl oleate | 2.9 |
| Non-ionic polymer blend ATLOX 4894 | 12.2 |
| Hydrophilic methyl methacrylate graft polymer | 1.2 |
| ATLOX 4913 | |
| linear polysaccharide | 0.3 |
| 1,2-benzothiazolin-3-one | 0.2 |
| Propylene glycol | 4.7 |
| sodium salt of naphthalenesulfonic | 0.5 |
| acid-formaldehyde condensate | |
| polydimethylsiloxane antifoam | 0.3 |
| water | to 100 |

TABLE 2
Suspoemulsion B

| | |
|---|---|
| azoxystrobin | 18.2 |
| propiconazole | 11.4 |
| Methyl oleate | 2.9 |
| Non-ionic polymer blend ATLOX 4894 | 4.0 |
| Hydrophilic methyl methacrylate graft polymer | 2.7 |
| ATLOX 4913 | |
| linear polysaccharide | 0.2 |
| 1,2-benzothiazolin-3-one | 0.2 |
| Propylene glycol | 4.6 |
| Blockcopolymer PO/EO | 6.0 |
| sodium salt of naphthalenesulfonic | 1.2 |
| acid-formaldehyde condensate | |
| polydimethylsiloxane antifoam | 0.5 |
| water | to 100 |

Biokinetic studies involving wheat leaves have shown that the foliar uptake of both the azoxystrobin and propiconazole in formulations prepared from Suspoemulsion A of the present invention is higher than the uptake of several market standard formulations which include QUADRIS™ fungicide (a suspension concentrate containing azoxystrobin), TILT™ fungicide (an emulsifiable concentrate containing propiconazole), STRATEGO™ fungicide (an emulsifiable concentrate containing trifloxystrobin and propiconazole) and HEADLINE™ fungicide (an emulsifiable concentrate containing pyraclostrobin).

For propiconazole, the foliar uptake from formulations of the present invention is faster and higher than from TILT™ or STRATEGO™. For azoxystrobin, the uptake of azoxystrobin from formulations prepared from Suspoemulsion A is higher than from QUADRIS™. Moreover, the uptake of azoxystrobin from formulations prepared from Suspoemulsion A into leaf cells is higher than trifloxystrobin from STRATEGO™ or pyraclostrobin from HEADLINE™.

Under most conditions and across major foliar diseases, the compositions of the present invention provide enhanced biological performance leading to better and longer lasting disease control and increased crop yield compared to either of the fungicides alone or certain other commercially-available fungicides and fungicide mixtures.

Fungicide compositions prepared from the suspoemulsions of the present invention provide improved crop safety compared to compositions containing the same amount of active ingredients and obtained by tank mixing azoxystrobin in the form of QUADRIS™ and propiconazole in the form of TILT™.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

We claim:

1. A suspoemulsion formulation comprising:
(A) a continuous aqueous phase;
(B) (i) a dispersed emulsion phase comprising at least one liquid, water-insoluble active ingredient comprising propiconazole;
(ii) an emulsifier in an amount sufficient to emulsify the liquid, water-insoluble ingredient(s); and
(c) (i) azoxystrobin, as a dispersed solid phase;
(iv) a dispersing agent in an amount sufficient to disperse the azoxystrobin as well as any other solid technical materials present in the formulation;
wherein the solid phase is dispersed in said aqueous and/or emulsion phase.

2. The suspoemulsion of claim 1 wherein the weight ratio of azoxystrobin to propiconazole is in the range from 5:1 to 1:5

3. The suspoemulsion of claim 1 wherein the propiconazole is dissolved in a solvent prior to forming the suspoemulsion.

4. The suspoemulsion of claim 3 wherein the solvent is selected from the group consisting of methyl esters of fatty acids derived from fats and oils, n-octanol, alkyl phosphates and isoparaffinic solvents.

5. The suspoemulsion of claim 4 wherein the solvent is a methyl ester of fatty acids and comprises methyl oleate.

6. A fungicidal composition obtained by diluting the suspoemulsion formulation according to claim 1 in water.

7. The fungicidal composition of claim 6 further comprising at least one member selected from the group consisting of herbicides, co-fungicides, insecticides, acaricides and nematicides.

8. A method of combating and/or preventing a fungal disease of a plant comprising applying to a plant, to the seed of a plant or to the locus of a seed or plant a fungicidally effective amount of the composition according to claim 6.

9. The method as claimed in claim 8 where the plant comprises at least one member selected from the group consisting of cereals, grass grown for seed, maize, pecans, rice and soya.

10. The method as claimed in claim 8 wherein the fungal disease comprises at least on member selected from the group consisting of Septoria, powdery mildew and leaf rust.
